(19) United States
(12) Patent Application Publication
(10) Pub. No.: US 2011/0007688 A1
(43) Pub. Date: Jan. 13, 2011

(54) METHOD AND APPARATUS FOR EVENT PRIORITIZATION AND ARBITRATION IN A MULTI-RADIO DEVICE

(75) Inventors: Venugopal V. Veeravalli, Urbana, IL (US); Ashok Mantravadi, San Diego, CA (US); Tamer A. Kadous, San Diego, CA (US); Joel B. Linsky, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/619,557

(22) Filed: Nov. 16, 2009

Related U.S. Application Data
(60) Provisional application No. 61/224,309, filed on Jul. 9, 2009.
(60) Provisional application No. 61/243,627, filed on Sep. 18, 2009.

(51) Int. Cl. H04W 4/00

(52) U.S. Cl. 370/328

(57) ABSTRACT

Systems and methodologies are described herein that facilitate prioritization and arbitration of radio events associated with a set of potentially conflicting radios supported by a wireless device. As described herein, bin-based priority can be implemented for respective radio events such that events are assigned to bins of varying priority levels based on factors such as functional correlations of respective events to data loss, event deadlines, or relative radio priorities. Subsequently, selection of an event combination can be performed based on bins to which respective events are assigned. Techniques are additionally described herein for arbitrating among conflicting radio events assigned to the same bin using random selection, history-based arbitration, or the like. As further described herein, arbitration can be adjusted to favor selection of new, ongoing, or previously events. Further, arbitration as described herein can be adjusted to accommodate events that execute in a plurality of decision units in time.

### CROSS-REFERENCE

This application claims the benefit of U.S. Provisional Application Ser. No. 61/224,309, filed Jul. 9, 2009, and entitled “PRIORITIZATION AND ARBITRATION OF EVENTS FROM MULTIPLE RADIOS IN A DEVICE,” and 61/243,627, filed Sep. 18, 2009, and entitled “METHOD AND APPARATUS FOR EVENT PRIORITIZATION AND ARBITRATION IN A MULTI-RADIO DEVICE,” the entirety of which is incorporated herein by reference.

### BACKGROUND

I. Field

The present disclosure relates generally to wireless communications, and more specifically to managing coexistence between multiple radios utilized by respective devices in a wireless communication system.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and Single-Carrier FDMA (SC-FDMA) systems.

Generally, a wireless multiple-access communication system can include a number of radios to support communication with different wireless communication systems. Respective radios can operate on certain frequency channels or bands or can have respective predefined requirements. In order to manage communication via multiple radios and avoid collisions and/or interference between respective radios, a coexistence manager (CxM) and/or other means can be utilized to coordinate between respective radios that are in collision (e.g., radios configured such that their mutual operation would cause significant interference on at least one of the radios). To these ends, it would be desirable to implement techniques for prioritizing and/or performing arbitration between respective colliding radios as well as events associated with such radios.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method is described herein. The method can comprise identifying a plurality of radio events associated with a corresponding set of radios for which notifications are provided and selecting a radio event combination from the plurality of radio events based on at least one of bins to which respective radio events are assigned, respective scale factors associated with the respective radio events, or respective history variables associated with the respective radio events

A second aspect described herein relates to a wireless communications apparatus, which can comprise a memory that stores data relating to respective radio events associated with a corresponding set of radios. The wireless communications apparatus can further comprise a processor configured to select a radio event combination composed of the respective radio events based on at least one of bins to which the respective radio events are assigned, respective scale factors associated with the respective radio events, or respective history variables associated with the respective radio events.

A third aspect relates to an apparatus, which can comprise means for obtaining information relating to respective radio events designated by respective corresponding radios and means for selecting a radio event combination from among the respective radio events based on at least one of bins, scale factors, or history variables associated with the respective radio events.

A fourth aspect described herein relates to a computer program product, which can include a computer-readable medium that comprises code for causing a computer to identify data relating to respective radio events associated with a corresponding set of radios and code for causing a computer to select a radio event combination composed of the respective radio events based on at least one of bins to which the respective radio events are assigned, respective scale factors associated with the respective radio events, or respective history variables associated with the respective radio events.

A fifth aspect described herein relates to an integrated circuit operable to execute a set of machine-executable instructions. The set of machine-executable instructions can comprise obtaining information relating to respective radio events designated by respective corresponding radios and selecting a radio event combination from among the respective radio events based on at least one of bins, scale factors, or history variables associated with the respective radio events.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is a block diagram of an example wireless communication environment in which various aspects described herein can function.

FIG. 2 is a block diagram of an example wireless device that can be operable to manage coexistence between respective radios in an associated wireless communication system in accordance with various aspects.

FIG. 3 illustrates an example set of radios that can be implemented in a wireless communication environment and respective potential collisions that can occur among the example set of radios.

FIG. 4 is a block diagram of a system for assigning and utilizing priorities for events associated with respective radios in a multi-radio communication environment in accordance with various aspects.

FIG. 5 illustrates an example priority scheme that can be utilized for radio event selection in accordance with various aspects.

FIG. 6 is a block diagram of a system for dynamically adjusting bin assignments associated with respective radio events in accordance with various aspects.

FIGS. 7-8 are block diagrams of respective systems for arbitrating among respective conflicting radio event combinations in accordance with various aspects.

FIG. 8 is a block diagram of a system for prioritizing radio events to be executed via respective radios associated with a wireless communication environment.

FIG. 9 is a flow diagram of a methodology for selecting a radio event from among respective conflicting radio events in a wireless communication environment.

FIG. 10 is a flow diagram of a methodology for performing bin assignment with respect to a set of radio events that can be performed by a multi-radio wireless device.

FIGS. 11-13 are flow diagrams of respective methodologies for performing arbitration between respective radio events.

FIG. 14 is a block diagram of an apparatus that facilitates prioritization of potentially conflicting radio events in a wireless communication system.

FIG. 15 is a block diagram of a wireless communications device that can be utilized to implement various aspects described herein.

FIGS. 16-17 are block diagrams that illustrate respective aspects of an example coexistence manager that can be utilized to implement various aspects described herein.

FIG. 18 illustrates operation of an example coexistence manager in time.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, it can be appreciated that various illustrative logical blocks, modules, circuits, algorithm steps, etc., described in connection with the disclosure herein can be implemented as electronic hardware, computer software, or combinations of both. To clearly illustrate this interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the disclosure herein can additionally or alternatively be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, or alternatively the processor can be any conventional processor, controller, microcontroller, state machine, or the like. A processor can also be implemented as a combination of computing devices, e.g., a combination of a DSP and a microprocessor, a plurality of microprocessors, one or more microprocessors in conjunction with a DSP core, or any other such configuration.

Furthermore, various functions of one or more example embodiments described herein can be implemented in hardware, software, firmware, or any combination thereof. If implemented in software, the functions can be stored on or transmitted as one or more instructions or code on a computer-readable medium. Computer-readable media can include both computer storage media and communication media. Communication media can include any medium that facilitates transfer of a computer program from one place to another. Likewise, storage media can include any available media that can be accessed by a general purpose or special purpose computer. By way of example, and not limitation, computer-readable media can comprise RAM, ROM, EEPROM, CD-ROM, digital versatile disc (DVD), blu-ray disc, or other optical disk storage, magnetic disk storage or other magnetic storage devices, and/or any other medium that can be used to carry or store desired program code means in the form of instructions or data structures and that can be accessed by a general-purpose or special-purpose computer or a general-purpose or special-purpose processor. Further, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and/or microwave, then such means are intended to be included in the definition of medium. “Disk” and “disc,” as used herein, includes compact disc (CD), laser disc, optical disc, DVD, floppy disk, and blu-ray disc, where “disks” generally reproduce data magnetically while “discs” reproduce data optically (e.g., with lasers). Combinations of the above can also be included within the scope of computer-readable media.

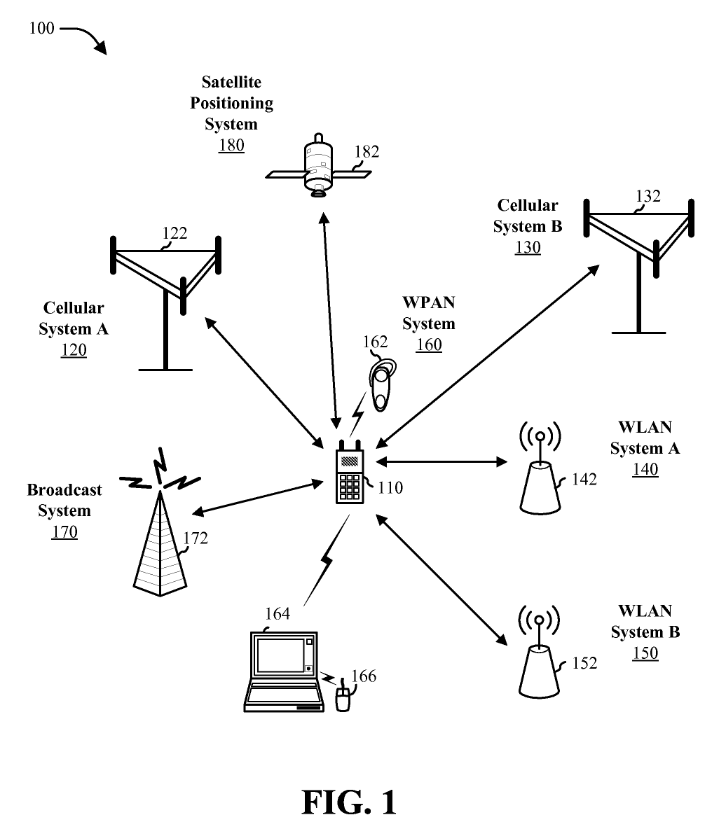

Referring now to the drawings, FIG. 1 illustrates an example wireless communication environment 100 in which various aspects described herein can function. Wireless communication environment 100 can include a wireless device 110, which can be capable of communicating with multiple communication systems. These systems can include, for example, one or more cellular systems 120 and/or 130, one or more wireless local area network (WLAN) systems 140 and/or 150, one or more wireless personal area network (WPAN) systems 160, one or more broadcast systems 170, one or more satellite positioning systems 180, other systems not shown in FIG. 1, or any combination thereof. It should be appreciated that in the following description the terms “network” and “system” are often used interchangeably.

Cellular systems 120 and 130 can each be a CDMA, TDMA, FDMA, OFDMA, SC-FDMA, or other suitable system. A CDMA system can implement a radio technology such as Universal Terrestrial Radio Access (UTRA), cdma2000, etc. UTRA includes Wideband CDMA (WCDMA) and other variants of CDMA. Moreover, cdma2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). In an aspect, cellular system 120 can include a number of base stations 122, which can support bi-directional communication for wireless devices within their coverage. Similarly, cellular system 130 can include a number of base stations 132 that can support bi-directional communication for wireless devices within their coverage.

WLAN systems 140 and 150 can respectively implement radio technologies such as IEEE 802.11 (Wi-Fi), Hiperlan, etc. WLAN system 140 can include one or more access points 142 that can support bi-directional communication. Similarly, WLAN system 150 can include one or more access points 152 that can support bi-directional communication. WPAN system 160 can implement a radio technology such as Bluetooth, IEEE 802.15, etc. Further, WPAN system 160 can support bi-directional communication for various devices such as wireless device 110, a headset 162, a computer 164, a mouse 166, or the like.

Broadcast system 170 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, broadcast system 170 can include one or more broadcast stations 172 that can support one-way communication.

Satellite positioning system 180 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, satellite positioning system 180 can include a number of satellites 182 that transmit signals used for position determination.

In an aspect, wireless device 110 can be stationary or mobile and can also be referred to as a user equipment (UE), a mobile station, a mobile equipment, a terminal, an access terminal, a subscriber unit, a station, etc. Wireless device 110 can be a cellular phone, a personal digital assistant (PDA), a wireless modem, a handheld device, a laptop computer, a cordless phone, a wireless local loop (WLL) station, etc. In addition, wireless device 110 can engage in two-way communication with cellular system 120 and/or 130, WLAN system 140 and/or 150, devices within WPAN system 160, and/or any other suitable system(s) and/or device(s). Wireless device 110 can additionally or alternatively receive signals from broadcast system 170 and/or satellite positioning system 180. In general, it can be appreciated that wireless device 110 can communicate with any number of systems at any given moment.

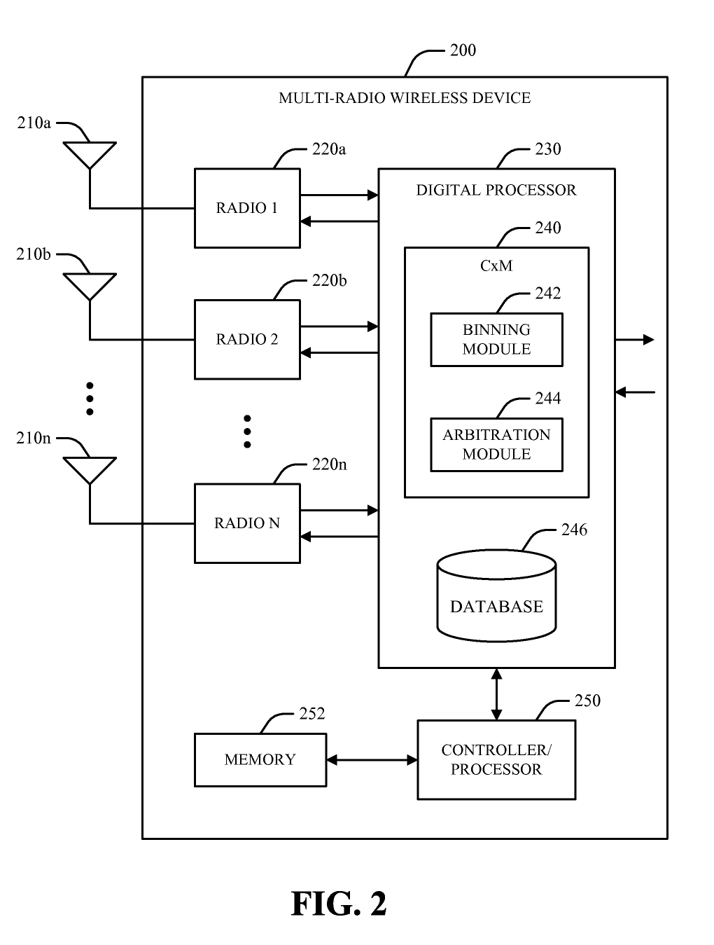

Turning next to FIG. 2, a block diagram is provided that illustrates an example design for a multi-radio wireless device 200. As FIG. 2 illustrates, wireless device 200 can include N radios 220a through 220n, which can be coupled to N antennas 210a through 210n, respectively, where N can be any integer value. It should be appreciated, however, that respective radios 220 can be coupled to any number of antennas 210 and that multiple radios 220 can also share a given antenna 210.

In general, a radio 220 can be a unit that radiates or emits energy in an electromagnetic spectrum, receives energy in an electromagnetic spectrum, or generates energy that propagates via conductive means. By way of example, a radio 220 can be a unit that transmits a signal to a system or a device or a unit that receives signals from a system or device. Accordingly, it can be appreciated that a radio 220 can be utilized to support wireless communication. In another example, a radio 220 can also be a unit (e.g., a screen on a computer, a circuit board, etc.) that emits noise, which can impact the performance of other radios. Accordingly, it can be further appreciated that a radio 220 can also be a unit that emits noise and interference without supporting wireless communication.

In accordance with one aspect, respective radios 220 can support communication with one or more systems. Multiple radios 220 can additionally or alternatively be used for a given system, e.g., to transmit or receive on different frequency bands (e.g., cellular and PCS bands).

In accordance with another aspect, a digital processor 230 can be coupled to radios 220a through 220n and can perform various functions, such as processing for data being transmitted or received via radios 220. The processing for each radio 220 can be dependent on the radio technology supported by that radio and can include encryption, encoding, modulation, etc., for a transmitter; demodulation, decoding, decryption, etc., for a receiver, or the like. In one example, digital processor 230 can include a coexistence manager (CxM) 240 that can control the operation of radios 220 in order to improve the performance of wireless device 200 as generally described herein. CxM 240 can have access to a database 246, which can store information used to control the operation of radios 220.

For simplicity, digital processor 230 is shown in FIG. 2 as a single processor. However, it should be appreciated that digital processor 230 can comprise any number of processors, controllers, memories, etc. In one example, a controller/processor 250 can direct the operation of various units within wireless device 200. Additionally or alternatively, a memory 252 can be used to store program codes and data for wireless device 200. Digital processor 230, controller/processor 250, and memory 252 can be implemented on one or more integrated circuits (ICs), application specific integrated circuits (ASICs), etc. By way of specific, non-limiting example, digital processor 230 can be implemented on a Mobile Station Modem (MSM) ASIC.

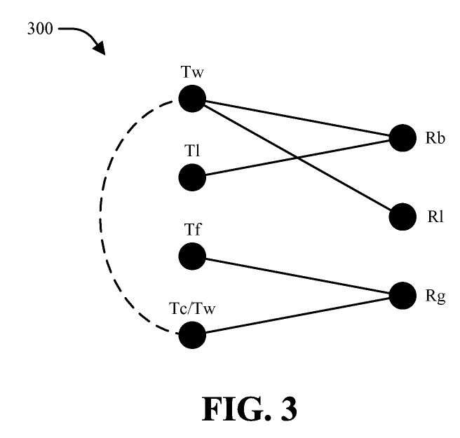

In accordance with one aspect, CxM 240 can be utilized to manage operation of respective radios 220 utilized by wireless device 200 in order to avoid interference and/or other performance degradation associated with collisions between respective radios 220. By way of further illustration, graph 300 in FIG. 3 represents respective potential collisions between seven example radios in a given decision period. In the example shown in graph 300, the seven radios include a WLAN transmitter (Tw), an LTE transmitter (Tl), an FM transmitter (Tf), a GSM/WCDMA transmitter (Tc), an LTE receiver (Rl), a Bluetooth receiver (Rb), and a GPS receiver (Rg). The four transmitters are represented by four nodes on the left side of graph 300, and the three receivers are represented by three nodes on the right side of graph 300. A potential collision between a transmitter and a receiver is represented on graph 300 by a branch connecting the node for the transmitter and the node for the receiver. Accordingly, in the example shown in graph 300, collisions may exist between (1) a WLAN transmitter (Tw) and a Bluetooth receiver (Rb); (2) a LTE transmitter (Tl) and a Bluetooth receiver (Rb); (3) a WLAN transmitter (Tw) and a LTE receiver (Rl); (4) a FM transmitter (Tf) and a GPS receiver (Rg); and (5) a WLAN transmitter (Tw), a GSM/WCDMA transmitter (Tc), and a GPS receiver (Rg).

In accordance with another aspect, CxM 240 can leverage the functionality of a binning module 242, an arbitration module 244, and/or any other suitable components to prioritize events or combinations of events associated with respective radios 220. For example, radios 220 associated with device 200 can in some cases interfere with each other through radiative, conductive, and/or other interference mechanisms. In some cases, such interference can render some event combinations impossible or otherwise impractical to occur across different radios simultaneously. In such cases, CxM 240 can leverage binning module 242, arbitration module 244, or the like to arbitrate between conflicting events based on priorities, scale factors, or other parameters assigned to the events of each radio 220.

In one example, binning module 242 and/or arbitration module 244 can be utilized to implement a combination of event binning (e.g., based on absolute priorities) for strict prioritization and scale factor based arbitration (e.g., based on relative priorities) for events that belong to the same bin. By utilizing such a prioritization procedure and/or other suitable procedures as described herein, a balance can be provided between strict prioritization and complete arbitration. More particularly, “strict prioritization” of a first event combination over a second event combination refers generally to a prioritization scheme wherein the first event combination is always chosen over the second event combination when the two event combinations occur. In contrast, by utilizing arbitration, a more balanced scheme can be leveraged wherein the first combination can be chosen in some cases and the second combination chosen in other cases. For example, arbitration can be configured to account for past history of event grants and denials and match desired success rates for the events. However, it should be appreciated that event prioritization and arbitration can be performed in any suitable manner as described herein and that, unless explicitly stated otherwise, the claimed subject matter provided herein is not intended to be limited to any specific implementation(s).

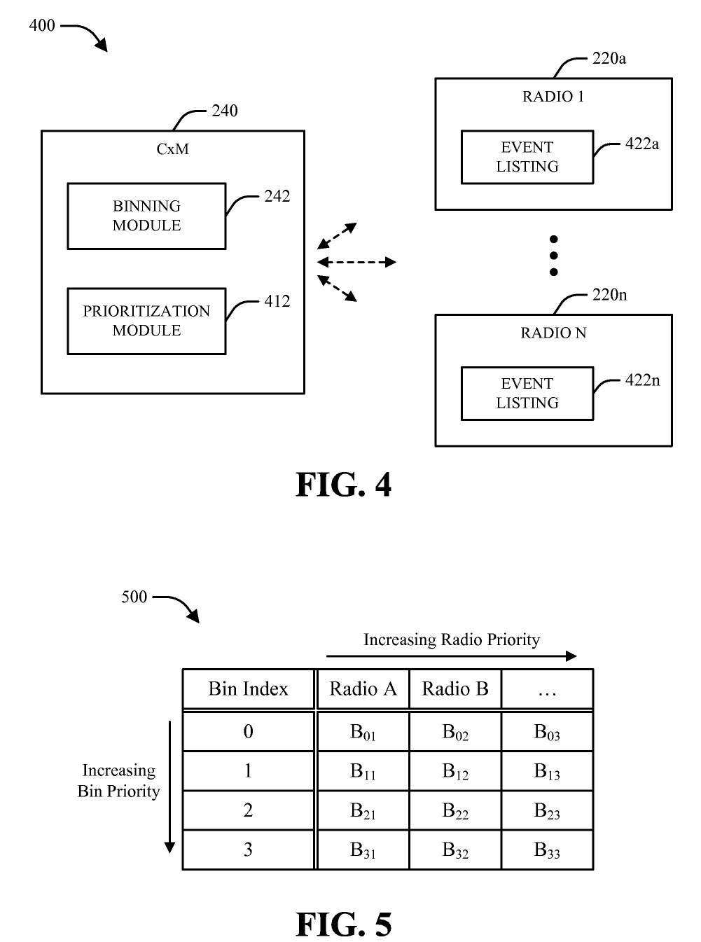

Referring next to FIG. 4, a block diagram of a system 400 for assigning and utilizing priorities for events associated with respective radios in a multi-radio communication environment in accordance with various aspects is illustrated. As shown in FIG. 4, system 400 can include a CxM 240, which can be utilized to monitor respective radios 220 and arbitrate and/or otherwise coordinate between one or more radios 220 that are in collision (e.g., such that mutual operation of the radios 220 causes severe interference to at least one of them). In one example, respective radios 220 can be associated with one or more events, which can be given by event listings 422 associated with respective radios 220 and/or in any other suitable manner. In another example, a binning module 242 at CxM 240 can be utilized to assign respective radios events associated with the radios 220 to respective bins based on factors such as functional correlations between respective events and data loss, deadlines associated with respective events or associated radios 220, relative priorities of respective radios 220, and/or other suitable factors. Based on bins to which respective radio events are assigned, a prioritization module 412 and/or other suitable means at CxM 240 can be utilized to select a radio event combination among a set of potentially conflicting radio event combinations to be executed.

Additionally or alternatively, prioritization module 412 can leverage multiple levels of prioritization for respective radio events. For example, sub-events of respective radio events can be prioritized for a given corresponding radio 220, where sub-events are defined as a single functional element at a radio 220 (e.g., a Channel Quality Indicator or CQI). Subsequently, an event priority can be determined based on relative priorities of the relevant sub-events that make up the event. In one example, an event can be defined as an independently resolvable function in a radio 220 (e.g., Physical Uplink Control Channel (PUCCH), Sounding Reference Signal (SRS), etc.). In another example, a radio priority structure utilized by CxM 240 can be further expanded, wherein a radio priority is determined based on a combination of events and a composite priority is determined based on combinations of radios 220.

In accordance with another aspect, binning module 242 can facilitate priority assignments across respective radios 220 by grouping respective sub-events into bins that are comparable for all radios 220. In one example, respective bins can be defined based on functional correlations to data loss, deadlines associated with respective events or associated radios 220, relative priorities of radios 220, or the like, in a manner that is applicable to all radios. Thus, by way of specific example, binning module 242 can define and utilize a bin structure as shown in Table 1 below, wherein the bins are listed in increasing order of priority:

TABLE 1
Example radio event bin structure.

1) Synchronization/Monitoring
Events that can be skipped without an immediate impact to data
decoding (e.g., updates to control information).
2) Data Loss
Actual decoding events, or events that lead to deterministic data
loss (or data loss with very high probability) if denied.
3) System Acquisition
Access or synchronization events that are a pre-requisite for decoding data.
4) Connection or System Loss
Events that, if denied, can lead to connection or system loss (e.g., events
following consistent data loss or acquisition failure for a predefined
period of time).
5) Ongoing Events
Ongoing events that cannot be pre-empted.

Based on the bin definitions shown in Table 1 above, event binning can be conducted by binning module 242 as shown in Tables 2-4 below. Specifically, Table 2 illustrates a set of LTE radio events, Table 3 illustrates a set of Forward Link Only (FLO) radio events, and Table 4 illustrates an example binning that can be conducted for the events listed in Tables 2-3. While Tables 2-4 illustrate an event binning example utilizing an LTE radio and a Forward Link Only (FLO) radio, it should be appreciated that the following example, as well as the bin definitions on which the following example is based, are intended only as specific, non-limiting examples of one aspect of the subject matter described herein.

TABLE 2
Example event listing for LTE (increasing order of priority).
Sub-events (increasing priority)

| | |
|---|---|
| 1. | SRS |
| 2. | PRACH |
| 3. | Data (QoS Class 0) |
| 4. | Data (QoS Class 1) |
| 5. | CQI/PMI |
| 6. | RI |
| 7. | Aperiodic CQI/PMI |
| 8. | Aperiodic RI |
| 9. | ACK |
| 10. | SR |

TABLE 3
Example event listing for FLO (increasing order ofpriority).
Sub-events (increasing priority)

| | |
|---|---|
| 1. | PPC |
| 2. | MFN CP correlation (monitor) |
| 3. | MFN RSSI measurement (monitor) |
| 4. | LOIS (monitor) |
| 5. | Local CC (monitor) |
| 6. | TDM2 |
| 7. | LIC |
| 8. | WIC |
| 9. | NRT MLC |
| 10. | RT MLC |
| 11. | Wide primary flow channel |
| 12. | Local CC (acquisition) |
| 13. | Wide CC |
| 14. | TDM1 Search |
| 15. | LOIS (acquisition) |
| 16. | WOIS (+ WIC/LIC/TDM2/WTPC) |
| 17. | SPC |
| 18. | MFN RSSI measurement (acquisition) |

TABLE 4
Example binning outputs for LTE and FLO events.

| Bin Definition | LTE Events | | FLO Events | |
|---|---|---|---|---|
| Synchronization or | 1. | SRS | 1. | PPC |
| Monitoring | 2. | CQI/PMI/RI (Periodic | 2. | MFN CP correlation |
| (Lowest) | | and Aperiodic) | 3. | MFN RSSI measurement |
| | | | 4. | LOIS |
| | | | 5. | Local CC |
| | | | 6. | TDM2 |
| | | | 7. | LIC |
| | | | 8. | WIC |
| | | | 9. | Wide primary flow channel |
| Data (one or more bins) | 1. | Data (QoS Class 0) | 1. | NRT MLC |
| | 2. | Data (QoS Class 1) | 2. | RT MLC |
| | 3. | ACK | 3. | Wide CC |
| | | | 4. | WOIS |
| System Acquisition | 1. | PRACH | 1. | Local CC |
| | 2. | SR | 2. | Wide CC |
| | | | 3. | TDM1 Search |
| | | | 4. | LOIS |
| | | | 5. | WOIS |
| | | | 6. | SPC |
| | | | 7. | MFN RSSI measurement |
| Connection or System Loss | 1. | Data (QoS Class 0) | 1. | NRT MLC |
| (Highest) | 2. | Data (QoS Class 1) | 2. | RT MLC |
| | 3. | ACK | 3. | Wide CC |
| | | | 4. | WOIS |

In one example, binning module 242 can place a set of radio events B_{xy} within a bin structure as shown in diagram 500 in FIG. 5, where bins and radios are arranged in increasing order of their respective priorities. With further reference to system 400 in FIG. 4, prioritization module 412 can enforce strict priority for respective bins, such that for elements Bₘₙ and Bᵣₛ, P(Bₘₙ)>P(Bᵣₛ) if m>r, where P( ) denotes priority. Alternatively, if m=r, prioritization module 412 can perform history-based, randomized, and/or other forms of arbitration as described in accordance with various aspects herein based on a set of scale factors and/or other suitable parameters. Accordingly, it can be appreciated that CxM 240 can utilize bin indices to control selection and radio indices and/or bin scale factors to control proportion.

In one example, when m=r, prioritization module 412 can perform randomization based on scale factors associated with respective events. Thus, in the example of two radios T1 and T2 having associated scale factors S₁ and S₂, radio T1 can be chosen with probability S₁/(S₁+S₂), or a probability equal to a scale factor of T1 divided by the sum of scale factors of T1 and T2. In another example, randomization as performed in this manner can be extended to randomly select a radio event combination (e.g., comprising one or more radio events) from respective potentially conflicting radio event combinations, based on the sum of the scale factors in the respective combinations.

In another example, prioritization module 412 can perform arbitration by first identifying respective event combinations that are absolutely incompatible or conditionally compatible (e.g., combinations present in an associated resolution table). Subsequently, the grant history for each possible selection in the respective combinations can be tracked. For example, in the example of a set of radios T1R2R3, grants can be tracked for T1, R2R3, T1R2, T1R3, and/or other combinations.

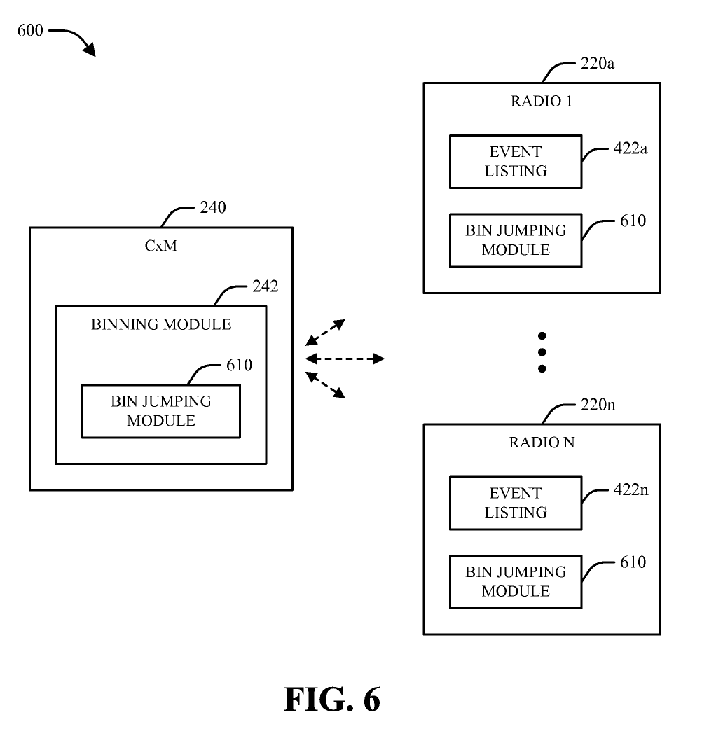

In accordance with a further aspect, bin assignments made by binning module 242 can be made dynamic and adjustable over time. For example, as illustrated by system 600 in FIG. 6, a binning module 242 associated with a CxM 240 can leverage the functionality of a bin jumping module 610, which can be utilized to alter a bin to which one or more radio events have previously been assigned. As additionally shown in system 600, respective radios can additionally or alternatively include bin jumping modules 610 to facilitate radio-side initialization of bin jumping.

In one example, bin jumping can be performed by a bin jumping module 610 associated with CxM 240 and/or a radio 220 to move one or more radio events to a higher priority bin upon satisfaction of predefined criteria. For example, bin jumping can be utilized to augment the binning procedure performed by binning module 242 as described above for an event that is denied (e.g., negatively acknowledged or NACKed) for a threshold period of time. Further, bin jumping can be performed to, for example, control the effects of randomization or arbitration of respective radio event combinations. Thus, for example, a long run of denials for a given radio 220 due to randomization can be overcome by CxM 240 and/or the affected radio 220 by utilizing bin jumping. In another example, bin jumping can be performed based on a deadline associated with a radio event. Accordingly, as the deadline of a given event approaches, a bin jumping module 610 can be utilized to move the event to higher priority bins in order to increase the probability that the event will be selected prior to its deadline.

Returning to FIG. 4, prioritization module 412 can be configured to perform various comparisons in connection with prioritizing respective event combinations that utilize common radios. For example, in a scenario in which notifications for events associated with a radio combination T1T2R3 are provided but radios T2 and R3 cannot coexist, prioritization module 412 can initially compute composite priorities for T1T2 and T1R3. Subsequently, if an event from radio T1 has a highest priority bin index while T2 and R3 have different bin indices, then arbitration can be performed between T1T2 and T1R3 as described in further detail herein. It can be appreciated that the above can in some cases differ from the operation of prioritization module 412 in a scenario wherein T2 and R3 occur without T1. Thus, it can further be appreciated that prioritization module 412 can be utilized to ensure that arbitration is performed only between combinations that are associated with the same respective bin indices (e.g., the same maximum, the same second maximum, and so on, up to a predetermined level of commonality).

In accordance with one aspect, an example procedure can be utilized by prioritization module 412 as follows to achieve the above ends. First, prioritization module 412 can identify substantially all maximally compatible combinations having a maximum bin index. Next, among these combinations, a combination with a second maximum bin index can be identified. Prioritization module 412 can then repeat this process for each successive maximum bin index until the combinations have equal maximum bin indices at substantially all orders or at a predefined threshold number of orders. In one example, prioritization module 412 can elect not to resolve combinations with lower ranks at the first iteration. Additionally or alternatively, CxM 240 can be configured to begin arbitration after the final winning combinations are confirmed to coexist based on an associated resolution table.

Additionally or alternatively, prioritization module 412 can operate as follows. For respective pairs of event combinations, prioritization module 412 can remove common events from both combinations in the respective pairs and determine the maximum bin indices for the remaining events in the combinations. Subsequently, if the resulting maximum bin index for one of the two combinations in a given pair is lower than that of the other combination in the pair, the combination with the lower maximum can be discarded.

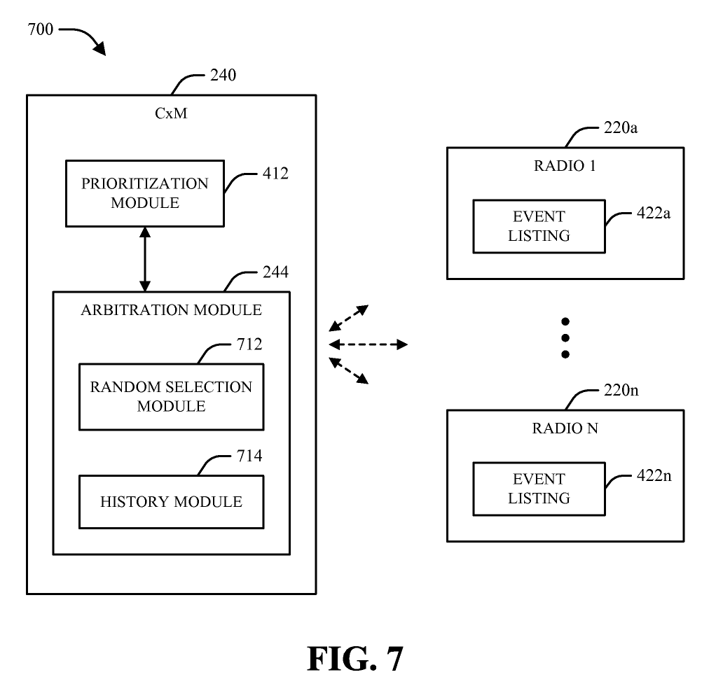

Referring next to FIG. 7, a block diagram of a system 700 for arbitrating among respective conflicting radio event combinations in accordance with various aspects is illustrated. As illustrated in FIG. 7, system 700 can include a CxM 240, which can utilize a prioritization module 412 in conjunction with an arbitration module 244 in order to perform arbitration for conflicting radio events associated with respective radios 220 (e.g., as provided by respective event listings 422). In one example, arbitration module 244 can arbitrate between conflicting radio events that belong to (or have components that belong to) the maximal bin index in a given decision unit (DU).

In accordance with one aspect, arbitration module 244 can utilize a random selection module 712 to arbitrate between respective radio events based on random selection between the respective events according to scale factors and/or other parameters associated with the respective events. Additionally or alternatively, arbitration module 244 can utilize a history module 714, which can be leveraged by arbitration module 244 to facilitate history-based arbitration between conflicting radio events. In one example, history module 714 can facilitate history-based arbitration by maintaining a record of previous grants in order to modify the probability that respective events are scheduled.

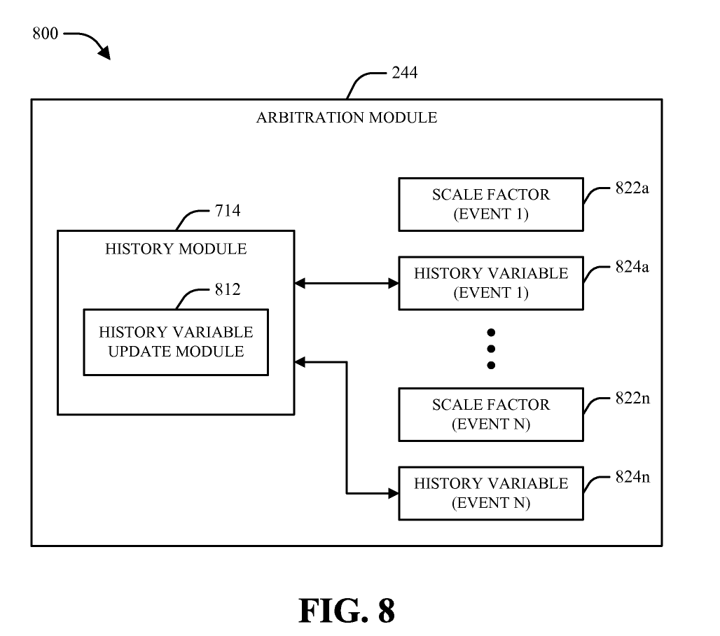

In accordance with one aspect, operation of an example arbitration module 244 and an associated history module 714 is illustrated in further detail by system 800 in FIG. 8. As illustrated by system 800, the desired probabilities with which respective events Eᵢ are to be scheduled can be controlled by scale factors sᵢ 822. In one example, scale factors 822 can be utilized to reflect the fraction of time (denoted herein by θᵢ) that a given event should be scheduled in arbitration. In another example, a scale factor 822 for a composite event can be made equal to the sum of scale factors of its component events. Thus, for example, for a conflict between events E₁ and E₂, arbitration can be performed by arbitration module 244 to enforce conditions

$${θ}_{1} = \frac{{s}_{1}}{{s}_{1} + {s}_{2}} and {θ}_{2} = \frac{{s}_{2}}{{s}_{1} + {s}_{2}} .$$

Similarly, in a conflict between (E₁, E₂) and E₃, arbitration can be performed by arbitration module 244 to enforce conditions

$${θ}_{12} = \frac{{s}_{1} + {s}_{2}}{{s}_{1} + {s}_{2} + {s}_{3}} and {θ}_{3} = \frac{{s}_{3}}{{s}_{1} + {s}_{2} + {s}_{3}} .$$

In accordance with another aspect, arbitration module 244 can select an arbitration scheme to meet a predetermined set of requirements. As a first example, an arbitration scheme can be chosen to match randomization (e.g., in steady state) if an event combination remains the same for a number of successive DUs. As a second example, when a transition occurs from an arbitration involving a given event to another arbitration involving the same event (e.g., E₁ vs. E₂ to (E₁,E₃) vs. E₄), updates to respective associated history variables 824 can be performed (e.g., by a history variable update module 812) such that the common event (e.g., E₁) does not receive an unfair disadvantage or advantage. In a third example, an arbitration scheme can be designed to maximize a predetermined utility function.

Various examples of arbitration that can be performed by arbitration module 244 in system 800 presented in the following description. It should be appreciated, however, that unless explicitly stated otherwise, the hereto appended claims are not intended to be limited to such examples.

In a first example procedure involving a conflict between events E₁ and E₂, arbitration module 244 (e.g., with the aid of history module 714) can implement a decision rule such that E₁ is chosen if

$$\frac{{s}_{1}}{{r}_{1} ( t )} > \frac{{s}_{2}}{{r}_{2} ( t )} ,$$

where r(t) is a history function that is updated by history variable update module 812 to increase the probability that an event will be selected when the event is denied and to decrease the probability that an event will be selected when the event is granted. This can be expressed as the update rule rᵢ(t+1)=(1−τ)rᵢ(t)+τxᵢI_{E}_{ᵢ}, where τ specifies the history length utilized by the update function (e.g., in DUs) and I_{E}_{ᵢ} is equal to 1 if event Eᵢ is granted or 0 otherwise. In one example, variables x₁ and x₂ can be chosen by arbitration module 244 to meet the above requirements for arbitration, such that, in steady state, rᵢ≈μᵢxᵢ and s₁/r₁≈s₂/r₂ where μᵢ represents the fraction of time that event Eᵢ is selected.

In accordance with one aspect, in order to ensure that arbitration performed by arbitration module 244 according to the above procedure matches randomization in steady state, xᵢ and x₂ can be set to equal values. Further, to ensure that radios are not unfairly advantaged or disadvantaged, the ratios s₁/r₁ and s₂/r₂ can be set equal to a constant c, which can be a universal constant that is independent of sᵢ (e.g., c=1 without loss of generality). Accordingly, it can be appreciated that the requirements for arbitration as provided above can be met by arbitration module 244 by setting x₁=x₂=s₁+s₂:=s_{O}. Further, to meet the third requirement as provided above, arbitration can be performed by arbitration module 244 to maximize the utility function U(t)=Σᵢ₌₁²sᵢ log rᵢ(t).

In a second example arbitration procedure involving a conflict between events (E₁, E₂) and E₃, arbitration module 244 can implement a decision rule such that (E₁, E₂) is chosen if

$$\frac{{s}_{1} + {s}_{2}}{{r}_{1} ( t ) + {r}_{2} ( t )} > \frac{{s}_{3}}{{r}_{3} ( t )} .$$

Further, rᵢ(t) can be controlled by history variable update module 812 and/or other suitable means associated with arbitration module 244 based on the update rule rᵢ(t+1)=(1−τ)rᵢ(t)+τxᵢI_{E}_{ᵢ}, and variables x₁-x₃ can be chosen by

$${x}_{3} = \frac{{s}_{3}}{{θ}_{3}} = {s}_{o} , \\ {x}_{1} = \frac{{s}_{1}}{{θ}_{12}} = \frac{{s}_{1}}{{s}_{1} + {s}_{2}} {s}_{o} , \\ and$$

$${x}_{2} = \frac{{s}_{2}}{{θ}_{12}} = \frac{{s}_{2}}{{s}_{1} + {s}_{2}} {s}_{o} .$$

In addition, arbitration can be performed by arbitration module 244 according to the above procedure to maximize the utility function U(t)=(s₁+s₂) log(r₁(t)+r₂(t))+s₃ log r₃ (t).

In a third example arbitration procedure involving a conflict between events (E₁, E₂), (E₁, E₃), and E₄, arbitration module 244 can implement a decision rule such that an event is chosen based on a comparison between

$$\frac{{s}_{1} + {s}_{2}}{{r}_{1} ( t ) + {r}_{2} ( t )} , \\ \frac{{s}_{1} + {s}_{3}}{{r}_{1} ( t ) + {r}_{3} ( t )} , \\ and$$

$$\frac{{s}_{4}}{{r}_{4} ( t )} .$$

In one example, history variable update module 812 and/or other suitable means associated with arbitration module 244 can control rᵢ(t) based on the update rule rᵢ(t+1)=(1−τ)rᵢ(t)+τxᵢI_{E}_{ᵢ}, and variables x₁-x₄ can be chosen by arbitration module 244 using

$${x}_{4} = \frac{{s}_{4}}{{θ}_{4}} , \\ {x}_{2} = \frac{{s}_{2}}{{θ}_{12}} , \\ {x}_{3} = \frac{{s}_{3}}{{θ}_{13}} , \\ and$$

$${x}_{1} = \frac{{s}_{1}}{{θ}_{12} + {θ}_{13}} .$$

In accordance with one aspect, the above example arbitration procedures can be summarized as follows. Initially, arbitration module 244 can implement a decision rule by comparing the ratios of the sum of scale factors 822 of respective event combinations to the sum of history variables 824 corresponding to the respective event combinations to obtain the event combination with the maximum obtained ratio. In addition, an update rule rᵢ(t+1)=(1−τ)rᵢ(t)+τxᵢI_{E}_{ᵢ} can be applied with

$${x}_{i} = \frac{{s}_{i}}{{θ}_{i , tot}} ,$$

where θ_{i,tot} represents the sum of time fractions of all event combinations that include event Eᵢ. In one example, the above can additionally be utilized in the special case where Eᵢ does not conflict with any other event in a DU, in which case xᵢ=sᵢ.

In accordance with another aspect, history module 714 can leverage the dynamics of respective s to r ratios in initializing r for new events for which no history exists. For example, a new event can be given a competitive advantage by history module 714 relative to existing events (e.g., corresponding to being denied in one or more DUs) in some cases. This can be done by, for example, defining the history of a new event as r_{new}(0)=s_{new}(1−τ)ⁿ^{₀}, where n₀ represents the number of DUs of advantage that is given to the new event.

In one example, arbitration module 244 can be configured to accommodate delayable events, which are events that can be scheduled at any time from a current DU until a deadline D. In one example, history module 714 can apply a competitive disadvantage to a delayable event corresponding to the time to its deadline by decreasing s pursuant to s_{delayable}→(1−τ)^{D}s_{delayable}.

In another example, events assigned to a lower priority bin than a winning event combination in an arbitration that can coexist with the winning event combination can be given a free ride such that, for example, the history variables 824 of the respective events are not updated. In one example, scale factors 822 of events assigned to lower priority bins can be increased in a similar manner to events in a winning event combination to prevent preemption in the event that the lower priority events last longer than the winning event combination. In another example, if two conflicting events assigned to lower priority bins than a winning event combination can coexist with the winning event combination, arbitration module 244 can arbitrate between the lower priority events. In such an example, history variables 824 associated with the lower priority events can be updated (e.g., up or down based on the arbitration between the lower priority events).

In accordance with a further aspect, arbitration module 244 can accommodate events that execute over a plurality of DUs in the following manner. By definition, when a multi-DU event is denied, it is denied in all DUs. Conversely, when a multi-DU event is accepted, it is accepted in all subsequent DUs (e.g., until a new event comes along). In an aspect, history module 714 and/or history variable update module 812 can account for this definition by rewarding and penalizing events such that events are rewarded for all denied DUs, tracking events that have been denied (e.g., “ghost” events) to set rewards, or the like.

A first example of an arbitration scheme that can be employed by arbitration module 244 for a multi-DU event (e.g., an event Eᵢ that spans Nᵢ DUs) is as follows. If Eᵢ is denied, history variable update module 812 can decrease rᵢ by a factor of (1−τ)^{N}^{ᵢ}, Nᵢ(1−τ), and/or any other suitable factor. Alternatively, if Eᵢ is granted, history variable update module 812 can increase rᵢ in each DU for which Eᵢ executes based on both real and “ghost” events in said DUs. As used herein, the term “ghost events” refers to events that have been denied in earlier DUs but would have been present in the current DU if they had been granted (e.g., such that their ending times are greater than or equal to the current DU). In one example, to prevent preemption of ongoing events, the scale factor 822 of an event can be increased temporarily during the event based on, for example, sᵢ(t+1)=(1+ε)sᵢ(t). If, despite the increased scale factor, Eᵢ is preempted, history variable update module 812 can give rᵢ the same reward as a denied event.

In a second example of an arbitration scheme that can be employed by arbitration module 244 for a multi-DU event, rewards and penalties can be scaled down by history variable update module 812 to the order of τ. Accordingly, rᵢ can be decreased by a factor of (1−τ) upon Eᵢ being denied, or alternatively rᵢ can be increased once at the end of the event using an average of single DU penalties based on both real and “ghost” events in the DU upon Eᵢ being granted. In a similar manner to the first example above, the scale factor of an ongoing event can be increased temporarily during the event based on, for example, sᵢ(t+1)=(1+ε)sᵢ(t), to prevent preemption of the event. If, despite the increased scale factor, Eᵢ is preempted, history variable update module 812 can give rᵢ the same reward as a denied event. In another example, updates to rᵢ made by history variable update module 812 as described above can occur at respective event boundaries (e.g., as opposed to respective DUs).

In a third example of an arbitration scheme that can be employed by arbitration module 244 for a multi-DU event, history variable update module 812 can decrease rᵢ by a factor of (1−τ) upon Eᵢ being denied. Alternatively, upon Eᵢ being granted, history variable update module 812 can configure rᵢ to be updated only in DUs where Eᵢ competes with other events or where Eᵢ goes to a competition-free DU. Further, the scale factor of an ongoing event can be increased temporarily during the event based on, for example, sᵢ(t+1)=(1+ε)sᵢ(t), to prevent preemption of the event. If, despite the increased scale factor, Eᵢ is preempted, history variable update module 812 can decrease rᵢ by a factor of (1−τ) from the DU in which it was preempted.

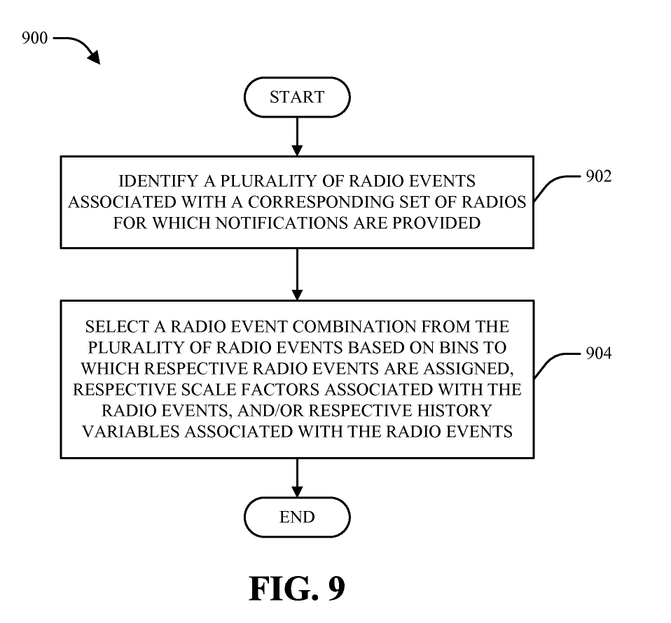

Referring now to FIGS. 9-13, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 9, illustrated is a methodology 900 for selecting a radio event from among respective conflicting radio events in a wireless communication environment. It is to be appreciated that methodology 900 can be performed by, for example, a wireless device (e.g., wireless device 110 or 200, via a CxM 240) and/or any other appropriate network device. Methodology 900 can begin at block 902, wherein a plurality of radio events associated with a corresponding set of radios (e.g., radios 220) for which notifications are provided are identified. Methodology 900 can then conclude at block 904, wherein a radio event combination is selected (e.g., by a prioritization component 412) from the plurality of radio events identified at block 902 based on bins to which respective radio events are assigned, respective scale factors associated with the radio events, and/or respective history variables associated with the radio events.

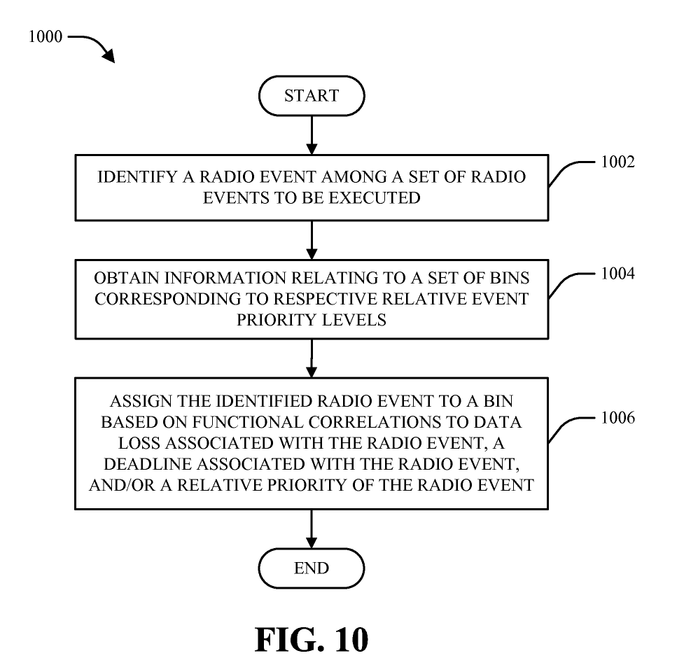

FIG. 10 illustrates a methodology 1000 for performing bin assignment with respect to a set of radio events that can be performed by a multi-radio wireless device. Methodology 1000 can be performed by, for example, a wireless terminal and/or any other suitable network entity. Methodology 1000 begins at block 1002, wherein a radio event is identified among a set of radio events to be executed. Next, at block 1004, information is obtained relating to a set of bins that correspond to relative event priority levels. Methodology 1000 can then conclude at block 1006, wherein the radio event identified at block 1002 is assigned to a bin in the set identified at block 1004 (e.g., by a binning module 242) based on functional correlations to data loss associated with the radio event, a deadline associated with the radio event, and/or a relative priority of the radio event.

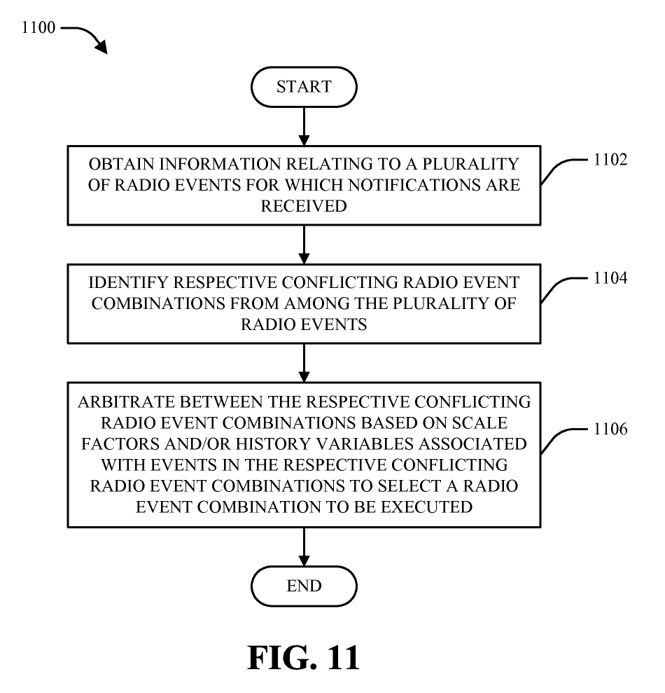

Turning next to FIG. 11, a methodology 1100 for performing arbitration between respective radio events is illustrated. Methodology 1100 can be performed by, for example, a multi-radio wireless device and/or any other suitable wireless network entity. Methodology 1100 can begin at block 1102, wherein information is obtained relating to a plurality of radio events for which notifications are received. Next, at block 1104, respective conflicting radio event combinations are identified from among the plurality of radio events identified at block 1102. Methodology 1100 can then conclude at block 1106, wherein a radio event combination to be executed is selected by arbitrating (e.g., via an arbitration module 244) between the respective conflicting radio event combinations identified at block 1104 based on scale factors and/or history variables associated with events in the respective conflicting radio event combinations.

In accordance with one aspect, in the event that a bin-based priority scheme is implemented, arbitration can be performed at block 1106 for a set of radio event combinations for which bin indices of the respective radio event combinations are substantially identical. More particularly, in an example involving a first radio event combination and a second radio event combination, arbitration can be performed upon determining that substantially all bin indices associated with the first radio event combination or a predefined number of highest priority bin indices associated with the first radio event combination match respective bin indices associated with the second radio event combination. In accordance with another aspect, arbitration can be performed for conflicting radio event combinations via randomization (e.g., by performing random selection based on sums of scale factors associated with the respective radio event combinations), history-based arbitration (e.g., by obtaining ratios for respective radio event combinations given in terms of a sum of scale factors associated with a radio event combination compared to a sum of history variables associated with the radio event combination and selecting a radio event combination having a maximum ratio), and/or any other suitable arbitration techniques in addition to, or in place of, the acts described at block 1106.

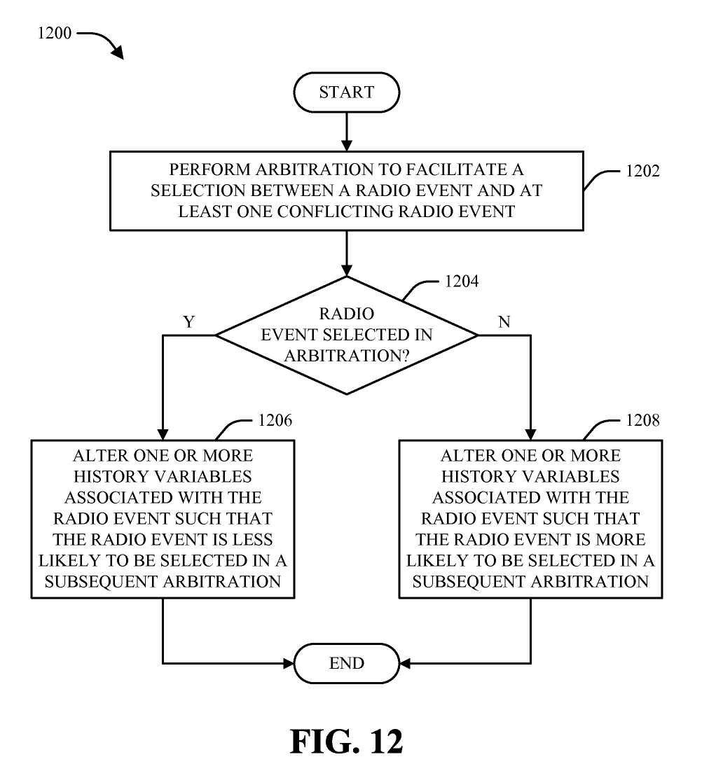

FIG. 12 illustrates a methodology 1200 for updating history variables (e.g., updating history variables 824 using a history variable update module 812) associated with respective radio events in connection with an arbitration scheme utilized for the respective radio events. Methodology 1200 can be performed by, for example, a wireless terminal and/or any other suitable network entity. Methodology 1200 begins at block 1202, wherein arbitration is performed to facilitate a selection between a given radio event and at least one conflicting radio event. Next, at block 1204, methodology 1200 can branch to block 1206 or to block 1208 based on whether the given radio event was selected in the arbitration at block 1202.

If the radio event was selected at block 1202, methodology 1200 can conclude at block 1206, wherein one or more history variables associated with the radio event are altered such that the radio event is less likely to be selected in a subsequent arbitration. By way of specific example, a history variable can be altered at block 1206 by performing a first multiplication of the history variable with 1 minus a history window value between 0 and 1, performing a second multiplication of the history window value with a penalty parameter computed as a function of scale factors associated with a corresponding radio event combination or one or more radio event combinations with which the corresponding radio event combination was conflicting, and updating the history variable to a result of the first multiplication plus a result of the second multiplication.

Otherwise, if the radio event was not selected at block 1202, methodology 1200 can instead conclude at block 1208, wherein one or more history variables associated with the radio event are altered such that the radio event is more likely to be selected in a subsequent arbitration. By way of specific example, a history variable can be altered at block 1208 by setting the history variable to a history window value between 0 and 1 multiplied by a penalty parameter computed as a function of scale factors associated with a corresponding radio event combination or one or more radio event combinations with which the corresponding radio event combination was conflicting.

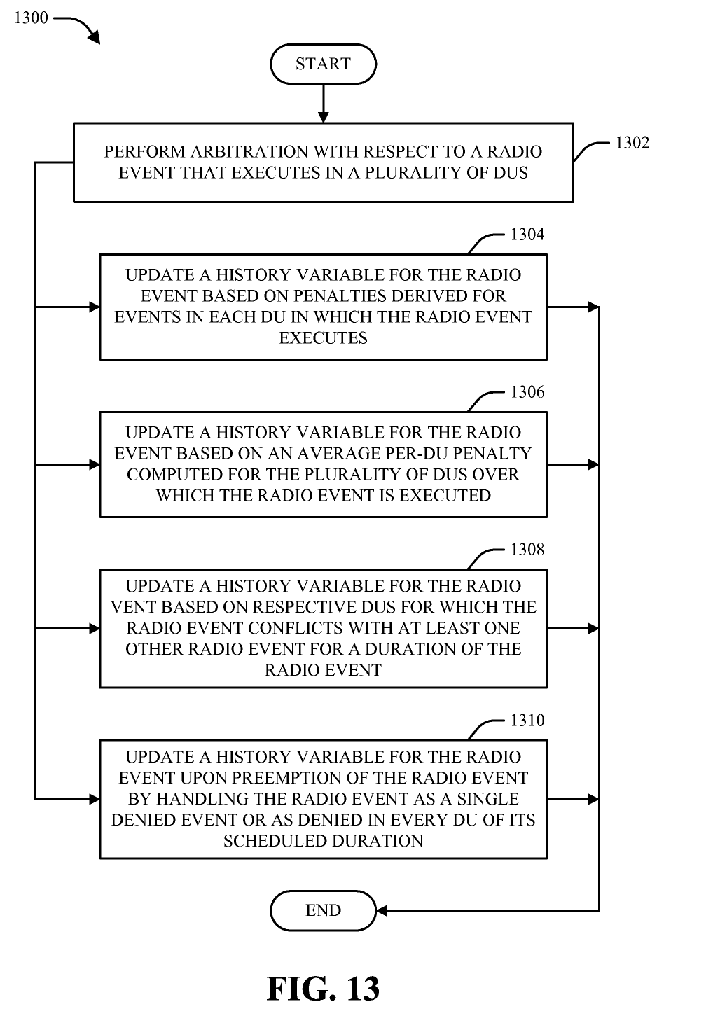

Referring to FIG. 13, a methodology 1300 for performing updating history variables associated with respective multi-DU events processed by an arbitration procedure is illustrated. Methodology 1300 can be performed by, for example, a multi-radio wireless device and/or any other suitable network device. Methodology 1300 can begin at block 1302, wherein arbitration is performed with respect to a radio event that executes in a plurality of DUs. Upon completion of the acts described at block 1302 and completion of the corresponding radio event, methodology 1300 can conclude by updating a history variable associated with the radio event as illustrated at block 1304, block 1306, block 1308, and/or block 1310. More particularly, at block 1304, a history variable for the radio event is updated based on penalties derived for events in each DU in which the radio event executes. At block 1306, a history variable for the radio event is updated based on an average per-DU penalty computed for the plurality of DUs in which the radio event executes. At block 1308, a history variable for the radio event is updated based on respective DUs over a duration of the radio event for which the radio event conflicts with at least one other radio event. At block 1310, a history variable for the radio event can be updated upon preemption of the radio event during the plurality of DUs in which it executes by handling the radio event as a single denied event or as being denied in every DU of its scheduled duration.

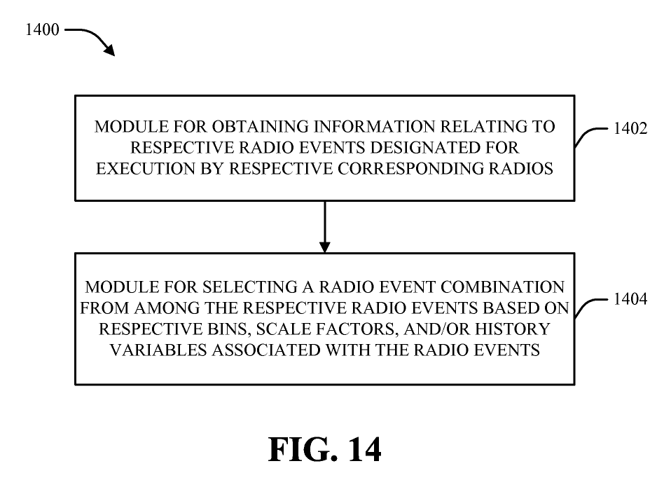

Turning now to FIG. 14, an apparatus 1400 that facilitates prioritization of potentially conflicting radio events in a wireless communication system is illustrated. It is to be appreciated that apparatus 1400 is represented as including functional blocks, which can be functional blocks that represent functions implemented by a processor, software, or combination thereof (e.g., firmware). Apparatus 1400 can be implemented by a wireless device (e.g., wireless device 110 or 200) and/or another suitable network entity and can include a module 1402 for obtaining information relating to respective radio events designated for execution by respective corresponding radios and a module 1404 for selecting a radio event combination from among the respective radio events based on respective bins, scale factors, and/or history variables associated with the radio events.

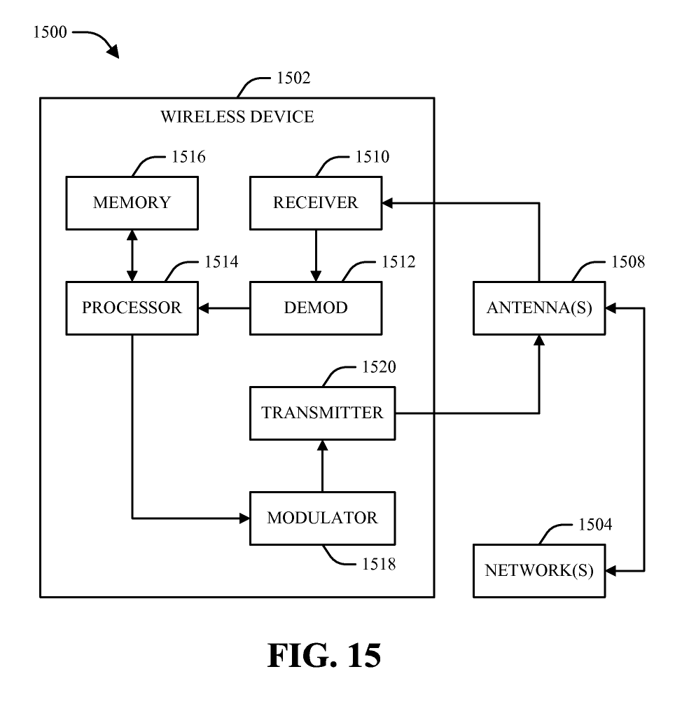

FIG. 15 is a block diagram of a system 1500 that can be utilized to implement various aspects of the functionality described herein. In one example, system 1500 includes a wireless device 1502. As illustrated, wireless device 1502 can receive signal(s) from one or more networks 1504 and transmit to the one or more networks 1504 via one or more antennas 1508. Additionally, wireless device 1502 can comprise a receiver 1510 that receives information from antenna(s) 1508. In one example, receiver 1510 can be operatively associated with a demodulator (Demod) 1512 that demodulates received information. Demodulated symbols can then be analyzed by a processor 1514. Processor 1514 can be coupled to memory 1516, which can store data and/or program codes related to terminal 1502. Additionally, wireless device 1502 can employ processor 1514 to perform methodologies 900-1300 and/or other similar and appropriate methodologies. Wireless device 1502 can also include a modulator 1518 that can multiplex a signal for transmission by a transmitter 1520 through antenna(s) 1508.

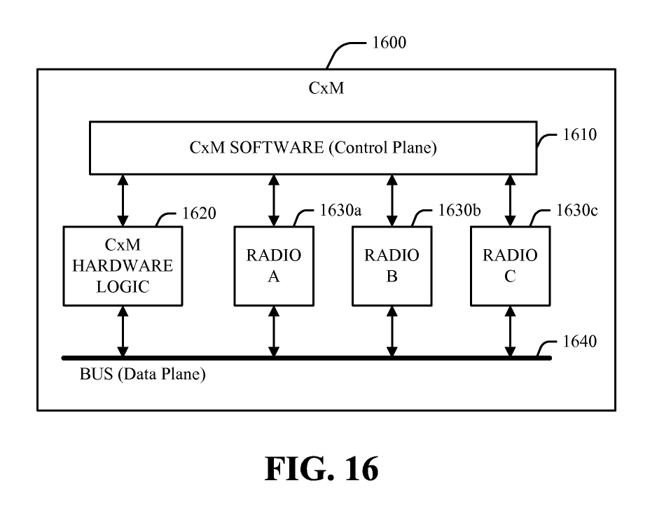

Turning next to FIG. 16, an example implementation of a CxM 1600 that can be utilized to implement various aspects described herein is illustrated. In one example, if multiple radios that can potentially interfere with each other are utilized in a wireless communication system, CxM 1600 can be used to coordinate the respective radios. In one example, CxM 1600 can be implemented as a mixture of software and hardware by utilizing, for example, control plane CxM software 1610 and CxM hardware logic 1620.

In accordance with one aspect, CxM 1600 can be implemented as a centralized architecture such that respective radios 1630a-1630c can coordinate and/or send notifications to CxM hardware logic 1620, which can in turn send notifications back to respective radios 1630a-1630c. In another example, operation of CxM 1600 can be split into hardware and software to accommodate time scales associated with coexistence issues. For example, radios 1630a-1630c can provide notifications of an imminent radio event at a substantially fast time scale (e.g., on the order of 100-150 microseconds), and accordingly CxM hardware logic 1620 and/or a data plane bus 1640 between CxM hardware logic 1620 and radios 1630a-1630c can be utilized to accommodate expedient operation based on notifications. Additionally or alternatively, CxM software 1610 can be implemented in the control plane to facilitate operations that can occur on a slower time scale, such as coordination radios coming on or off, sleep mode operation, or the like.

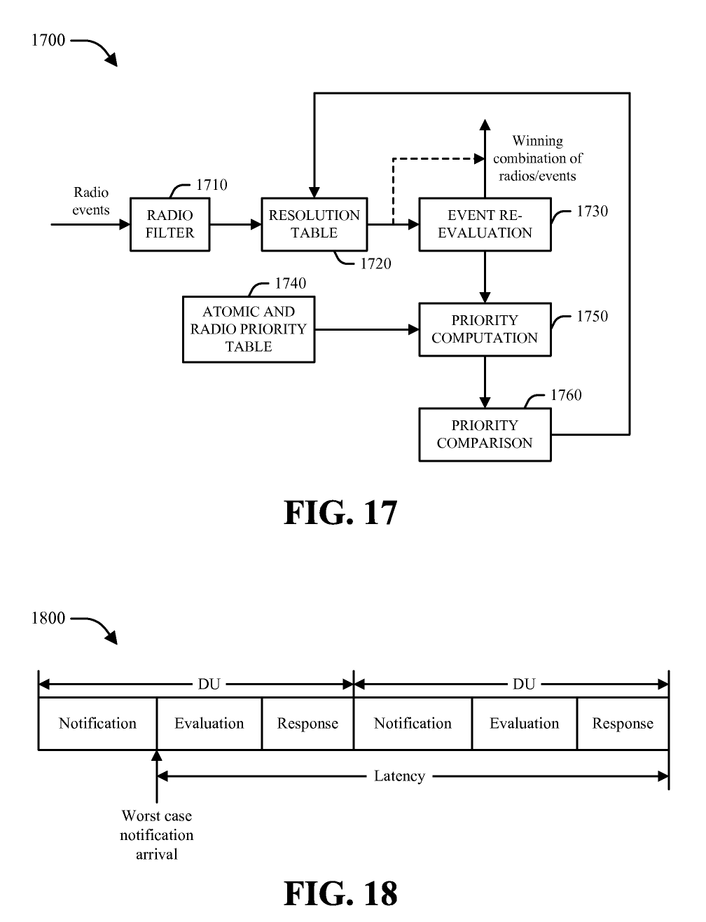

Diagram 1700 in FIG. 17 illustrates additional aspects of an example CxM implementation. As shown in diagram 1700, radio events can initially be processed by a radio filter 1710, which can identify groups or clusters of radios that can potentially interfere directly and/or indirectly. Next, a resolution table 1720 can be utilized to identify various parameters of the received events (e.g., transmit power, frequency subbands, receive power, tolerated interference, etc.) to determine whether the respective events can coexist.

Based on the operation of the resolution table 1720, an event re-evaluation block 1730 can then determine whether a highest priority (or “winning”) combination of radios and/or events exists. If such a combination does not exist, priority computation block 1750 can determine relative priorities associated with events and/or groups of events. In one example, priority computation block 1750 can leverage an atomic and radio priority table 1740, which can be implemented as a table per radio carrying priorities of atomic events and another table carrying relative priorities across radios. In an example, both of such tables can be configured by CxM software and can be static over a given CxM software update.

Based on priorities obtained by priority computation block 1750, arbitration can be performed for various combinations of events via priority comparison block 1760. In accordance with one aspect, priority comparison block 1760 can select the highest priority combination of events and provide such information to resolution table 1720 for re-evaluation.

Turning to diagram 1800 in FIG. 18, an example timeline for CxM operation is illustrated. In one example, a CxM can operate according to a timeline divided into decision units (DUs) in time, which can be any suitable uniform or non-uniform length (e.g., 100 μs). By way of specific example, a DU can be divided into a notification phase (e.g., 50 μs) where various radios send notifications of imminent events, an evaluation phase (e.g., 30 μs) where notifications are processed, and a response phase (e.g., 20 μs) where commands are provided to various radios and/or other operations are performed based on actions taken in the evaluation phase. In one example, timeline 1800 can have a latency parameter defined by the worst case operation of timeline 1800, e.g., the timing of a response in the case that a notification is obtained from a given radio immediately following termination of the notification phase in a given DU.

With respect to the above description, one of ordinary skill in the art can appreciate that various aspects described above can be implemented by hardware, software, firmware, middleware, microcode, or any combination thereof. When the systems and/or methods are implemented in software, firmware, middleware or microcode, program code or code segments, they can be stored in a machine-readable medium, such as a memory or storage device. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

Moreover, those of skill in the art can appreciate that information and signals can be represented using any of a variety of different technologies and techniques. For example, data, instructions, commands, information, signals, bits, symbols, and/or chips that may be referenced throughout the above description can be represented by voltages, currents, electromagnetic waves, magnetic fields or particles, optical fields or particles, or any combination thereof.

In addition, it is to be understood that the steps of the various methods and/or algorithms as described in connection with the disclosure above can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An example storage medium can be coupled to a processor such that the processor can read information from, and write information to, the storage medium. In the alternative, the storage medium can be integral to the processor. The processor and the storage medium can reside in an ASIC, which in turn can reside in a user terminal and/or in any other suitable location. Alternatively, processor and the storage medium can reside as discrete components in a user terminal.

The above description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is instead to be accorded the widest scope consistent with the principles and novel features disclosed herein. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
identifying a plurality of radio events associated with a corresponding set of radios for which notifications are provided; and
selecting a radio event combination from the plurality of radio events based on at least one of bins to which respective radio events are assigned, respective scale factors associated with the respective radio events, or respective history variables associated with the respective radio events.

2. The method of claim 1, further comprising assigning respective radio events to corresponding bins based at least in part on functional correlations of the respective radio events to data loss, deadlines associated with the respective radio events, or relative priorities of radios associated with the respective radio events.

3. The method of claim 2, wherein the assigning comprises:
identifying respective sub-events associated with a given radio event; and
assigning the given radio event to a bin corresponding to a highest priority sub-event of the given radio event.

4. The method of claim 1, further comprising associating scale factors with respective radio events based at least in part on functional correlations of the respective radio events to data loss, deadlines associated with the respective radio events, or relative priorities of radios associated with the respective radio events.

5. The method of claim 1, further comprising moving a radio event from an associated bin to a disparate, higher priority bin as a function of previous denials of the radio event or a deadline associated with the radio event.

6. The method of claim 5, wherein the moving is performed by a coexistence manager for the radio event.

7. The method of claim 5, wherein the moving is performed by a radio associated with the radio event.

8. The method of claim 1, wherein the selecting comprises arbitrating between respective conflicting radio event combinations based at least in part on scale factors associated with radio events in the respective radio event combinations.

9. The method of claim 8, wherein the arbitrating comprises:
identifying a first radio event combination and a second radio event combination that conflicts with the first radio event combination;
identifying a first set of bin indices with which respective radio events in the first radio event combination are associated and a second set of bin indices with which respective radio events in the second radio event combination are associated; and
arbitrating between the first radio event combination and the second radio event combination upon determining that substantially all bin indices in the first set of bin indices or a predefined number of highest priority bin indices in the first set of bin indices match respective bin indices in the second set of bin indices.

10. The method of claim 8, wherein the arbitrating comprises:
identifying a first radio event combination and a second radio event combination that conflicts with the first radio event combination;
removing respective radio events from the first radio event combination and the second radio event combination that are common to the first radio event combination and the second radio event combination; and
arbitrating between the first radio event combination and the second radio event combination based at least in part on maximum bin indices associated with respective radio events in the first radio event combination and the second radio event combination that remain after the removing.

11. The method of claim 8, wherein the arbitrating comprises arbitrating between respective radio event combinations by performing random selection based at least in part on sums of scale factors associated with the respective radio event combinations.

12. The method of claim 8, wherein the arbitrating comprises performing history-based arbitration between respective radio event combinations at least in part by obtaining ratios for respective radio event combinations, the ratios given in terms of a sum of scale factors associated with a radio event combination to a sum of history variables associated with the radio event combination, and selecting a radio event combination having a maximum ratio.

13. The method of claim 8, wherein the arbitrating comprises updating one or more history variables associated with a radio event combination upon selecting or denying the radio event combination as a function of respective scale factors associated with the radio event combination or respective scale factors associated with one or more radio event combinations with which the radio event combination was conflicting.

14. The method of claim 13, wherein the updating comprises altering one or more history variables associated with the radio event combination upon selection of the radio event combination such that the radio event combination is less likely to be selected in a subsequent arbitration.

15. The method of claim 14, wherein the altering comprises:
performing a first multiplication of a history variable with 1 minus a history window value, the history window value being a real number value between 0 and 1;
performing a second multiplication of the history window value with a penalty parameter computed as a function of scale factors associated with the radio event combination or one or more radio event combinations with which the radio event combination was conflicting; and
updating the history variable to a result of the first multiplication plus a result of the second multiplication.

16. The method of claim 13, wherein the updating comprises altering one or more history variables associated with the radio event combination upon denial of the radio event combination such that the radio event combination is more likely to be selected in a subsequent arbitration.

17. The method of claim 16, wherein the altering comprises setting the history variable to a history window value multiplied by a penalty parameter computed as a function of scale factors associated with the radio event combination or one or more radio event combinations with which the radio event combination was conflicting, the history window value being a real number value between 0 and 1.

18. The method of claim 13, further comprising updating a scale factor for a delayable radio event combination as a function of time to a deadline of the delayable radio event combination.

19. The method of claim 13, wherein the updating comprises updating a history variable for a radio event that executes in a plurality of decision units (DUs) based on a total length of the radio event.

20. The method of claim 19, wherein the updating further comprises updating the history variable for the radio event based on respective radio events that are denied during execution of the radio event.

21. The method of claim 13, wherein the updating comprises updating a history variable for a radio event that executes in a plurality of DUs based on an average per-DU penalty computed for the plurality of DUs over which the radio event is executed.

22. The method of claim 13, wherein the updating comprises updating a history variable for a radio event that executes in a plurality of DUs based on respective DUs for which the radio event conflicts with at least one other radio event during a duration of the radio event.

23. The method of claim 8, further comprising increasing a scale factor associated with an ongoing radio event during execution of the ongoing radio event, thereby rendering the ongoing radio event less likely to be preempted by respective radio event combinations that do not include the ongoing event.

24. The method of claim 8, further comprising:
identifying a new radio event for which no history exists; and
initializing a history variable for the new radio event such that the history variable for the new radio event is decreased relative to corresponding history variables for respective existing radio events, thereby rendering the new radio event more likely to be selected in a subsequent arbitration.

25. A wireless communications apparatus, comprising:
a memory that stores data relating to respective radio events associated with a corresponding set of radios; and
a processor configured to select a radio event combination composed of the respective radio events based on at least one of bins to which the respective radio events are assigned, respective scale factors associated with the respective radio events, or respective history variables associated with the respective radio events.

26. The wireless communications apparatus of claim 25, wherein the processor is further configured to assign the respective radio events to corresponding bins based at least in part on functional correlations of the respective radio events to data loss, deadlines associated with the respective radio events, or relative priorities of radios associated with the respective radio events.

27. The wireless communications apparatus of claim 26, wherein the processor is further configured to assign a radio event to a bin at least in part by identifying respective sub-events associated with the radio event and assigning the radio event to a bin corresponding to a highest priority sub-event of the radio event.

28. The wireless communications apparatus of claim 25, wherein the processor is further configured to associate scale factors with the respective radio events based at least in part on functional correlations of the respective radio events to data loss, deadlines associated with the respective radio events, or relative priorities of radios associated with the respective radio events.

29. The wireless communications apparatus of claim 25, wherein the processor is further configured to facilitate jumping of a radio event from an associated bin to a new, higher priority bin as a function of previous denials of the radio event or a deadline associated with the radio event.

30. The wireless communications apparatus of claim 29, wherein the processor is further configured to facilitate jumping of the radio event via a coexistence manager for the radio event.

31. The wireless communications apparatus of claim 29, wherein the processor is further configured to facilitate jumping of the radio event via a radio associated with the radio event.

32. The wireless communications apparatus of claim 25, wherein the processor is further configured to arbitrate between respective conflicting radio event combinations based at least in part on scale factors associated with radio events in the respective radio event combinations.

33. The wireless communications apparatus of claim 32, wherein:
the memory further stores data relating to a first radio event combination and a second radio event combination that conflicts with the first radio event combination; and
the processor is further configured to obtain information relating to bin indices with which respective radio events in the first radio event combination are associated, to obtain information relating to bin indices with which respective radio events in the second radio event combination are associated, and to arbitrate between the first radio event combination and the second radio event combination upon determining that substantially all bin indices associated with the first radio event combination or a predefined number of highest priority bin indices associated with the first radio event combination substantially match respective bin indices associated with the second radio event combination.

34. The wireless communications apparatus of claim 32, wherein:
the memory further stores data relating to a first radio event combination and a second radio event combination that conflicts with the first radio event combination; and
the processor is further configured to removing respective radio events from the first radio event combination and the second radio event combination that are common between the first radio event combination and the second radio event combination and to arbitrate between the first radio event combination and the second radio event combination based at least in part on maximum bin indices associated with respective remaining radio events in the first radio event combination and the second radio event combination.

35. The wireless communications apparatus of claim 32, wherein the processor is further configured to arbitrate between respective radio event combinations by performing random selection based at least in part on sums of scale factors associated with the respective radio event combinations.

36. The wireless communications apparatus of claim 32, wherein the processor is further configured to perform history-based arbitration between respective radio event combinations at least in part by obtaining ratios for respective radio event combinations given in terms of a sum of scale factors associated with a radio event combination to a sum of history variables associated with the radio event combination and selecting a radio event combination having a maximum obtained ratio.

37. The wireless communications apparatus of claim 32, wherein the processor is further configured to update respective history variables associated with a radio event combination upon selecting or denying the radio event combination as a function of respective scale factors associated with the radio event combination or respective scale factors associated with one or more radio event combinations with which the radio event combination conflicts.

38. The wireless communications apparatus of claim 37, wherein the processor is further configured to alter respective history variables associated with the radio event combination upon selection of the radio event combination such that the radio event combination is less likely to be selected in a subsequent arbitration.

39. The wireless communications apparatus of claim 38, wherein the processor is further configured to alter a history variable associated with a radio event combination at least in part by performing a first multiplication of the history variable with 1 minus a history window value, the history window value being a real number value between 0 and 1; performing a second multiplication of the history window value with a penalty parameter computed as a function of scale factors associated with the radio event combination or one or more radio event combinations with which the radio event combination conflicts; and updating the history variable to a result of the first multiplication plus a result of the second multiplication.

40. The wireless communications apparatus of claim 37, wherein the processor is further configured to alter respective history variables associated with the radio event combination upon denial of the radio event combination such that the radio event combination is more likely to be selected in a subsequent arbitration.

41. The wireless communications apparatus of claim 38, wherein the processor is further configured to alter a history variable associated with a radio event combination at least in part by setting the history variable to a history window value multiplied by a penalty parameter computed as a function of scale factors associated with the radio event combination or one or more radio event combinations with which the radio event combination conflicts, the history window value being a real number value between 0 and 1.

42. The wireless communications apparatus of claim 37, wherein the processor is further configured to update a scale factor for a delayable radio event combination as a function of time to a deadline of the delayable radio event combination.

43. The wireless communications apparatus of claim 37, wherein the processor is further configured to update a history variable for a radio event that executes in a plurality of decision units (DUs) based on a total length of the radio event.

44. The wireless communications apparatus of claim 43, wherein the processor is further configured to update the history variable for the radio event based on respective radio events that are denied during execution of the radio event.

45. The wireless communications apparatus of claim 37, wherein the processor is further configured to update a history variable for a radio event that executes in a plurality of DUs based on an average per-DU penalty computed for the plurality of DUs over which the radio event is executed.

46. The wireless communications apparatus of claim 37, wherein the processor is further configured to update a history variable for a radio event that executes in a plurality of DUs based on respective DUs for which the radio event conflicts with at least one other radio event during a duration of the radio event.

47. The wireless communications apparatus of claim 32, wherein the processor is further configured to increase a scale factor associated with an ongoing radio event during execution of the ongoing radio event in order to render the ongoing radio event less likely to be preempted by respective radio event combinations that do not include the ongoing event.

48. The wireless communications apparatus of claim 32, wherein:
the memory further stores data relating to a new radio event for which no history exists; and
the processor is further configured to initialize a history variable for the new radio event by decreasing the history variable for the new radio event relative to corresponding history variables for respective existing radio events in order to render the new radio event more likely to be selected in a subsequent arbitration.

49. An apparatus, comprising:
means for obtaining information relating to respective radio events designated by respective corresponding radios; and
means for selecting a radio event combination from among the respective radio events based on at least one of bins, scale factors, or history variables associated with the respective radio events.

50. The apparatus of claim 49, further comprising means for assigning the respective radio events to corresponding bins based at least in part on functional correlations of the respective radio events to data loss, deadlines associated with the respective radio events, or relative priorities of radios associated with the respective radio events.

51. The apparatus of claim 50, wherein the means for assigning comprises:
means for identifying respective sub-events associated with a radio event; and
means for assigning the radio event to a bin corresponding to a highest priority sub-event of the radio event.

52. The apparatus of claim 49, further comprising means for assigning scale factors to respective radio events based at least in part on functional correlations of the respective radio events to data loss, deadlines associated with the respective radio events, or relative priorities of radios associated with the respective radio events.

53. The apparatus of claim 49, further comprising means for moving a radio event from an associated bin to a higher priority bin as a function of previous denials of the radio event or a deadline associated with the radio event.

54. The apparatus of claim 53, wherein the means for moving is implemented by a coexistence manager for the radio event.

55. The apparatus of claim 53, wherein the means for moving is implemented by a radio associated with the radio event.

56. The apparatus of claim 49, wherein the means for selecting comprises means for arbitrating between respective conflicting radio event combinations according to scale factors associated with radio events in the respective radio event combinations.

57. The apparatus of claim 56, wherein:
the means for obtaining information comprises means for identifying a first radio event combination and a second radio event combination that conflicts with the first radio event combination, means for identifying a first set of bin indices with which respective radio events in the first radio event combination are associated, and means for identifying a second set of bin indices with which respective radio events in the second radio event combination are associated; and
the means for arbitrating comprises means for arbitrating between the first radio event combination and the second radio event combination upon determining that substantially all bin indices in the first set of bin indices or a predefined number of highest priority bin indices in the first set of bin indices match respective corresponding bin indices in the second set of bin indices.

58. The apparatus of claim 56, wherein:
the means for obtaining information comprises means for identifying a first radio event combination and a second radio event combination that conflicts with the first radio event combination; and
the means for arbitrating comprises means for removing respective common radio events between the first radio event combination and the second radio event combination from the first radio event combination and the second radio event combination and means for arbitrating between the first radio event combination and the second radio event combination based at least in part on maximum bin indices associated with respective remaining radio events in the first radio event combination and the second radio event combination subsequent to removal of common radio events.

59. The apparatus of claim 56, wherein the means for arbitrating comprises means for randomly selecting a radio event combination from among respective conflicting radio event combinations based at least in part on sums of scale factors associated with the respective conflicting radio event combinations.

60. The apparatus of claim 56, wherein the means for arbitrating comprises:
means for obtaining ratios for respective radio event combinations defined in terms of a sum of scale factors associated with a given radio event combination to a sum of history variables associated with the given radio event combination; and
means for selecting a radio event combination having a maximum obtained ratio.

61. The apparatus of claim 56, wherein the means for arbitrating comprises means for updating one or more history variables associated with a radio event combination upon selecting or denying the radio event combination as a function of respective scale factors associated with the radio event combination or respective scale factors associated with one or more radio event combinations with which the radio event combination conflicts.

62. The apparatus of claim 61, wherein the means for updating comprises means for altering one or more history variables associated with the radio event combination upon selection of the radio event combination such that the radio event combination is less likely to be selected in a subsequent arbitration.

63. The apparatus of claim 62, wherein the means for altering comprises:
means for conducting a first multiplication of a given history variable with 1 minus a history window value, the history window value being a real number value between 0 and 1;
means for conducting a second multiplication of the history window value with a penalty parameter computed as a function of scale factors associated with the radio event combination or one or more radio event combinations with which the radio event combination conflicts; and
means for updating the given history variable to a result of the first multiplication plus a result of the second multiplication.

64. The apparatus of claim 61, wherein the means for updating comprises means for altering one or more history variables associated with the radio event combination upon denial of the radio event combination such that the radio event combination is more likely to be selected in a subsequent arbitration.

65. The apparatus of claim 64, wherein the means for altering comprises means for setting a given history variable to a history window value multiplied by a penalty parameter computed as a function of scale factors associated with the radio event combination or one or more radio event combinations with which the radio event combination conflicts, the history window value being a real number value between 0 and 1.

66. The apparatus of claim 61, further comprising means for updating a scale factor for a delayable radio event combination as a function of time to a deadline of the delayable radio event combination.

67. The apparatus of claim 61, wherein the means for updating comprises means for updating a history variable for a radio event that executes in a plurality of decision units (DUs) based on a total length of the radio event.

68. The apparatus of claim 67, wherein the means for updating further comprises means for updating the history variable for the radio event based on respective radio events that are denied during execution of the radio event.

69. The apparatus of claim 61, wherein the means for updating comprises means for updating a history variable for a radio event that executes in a plurality of DUs based on an average per-DU penalty computed for the plurality of DUs over which the radio event is executed.

70. The apparatus of claim 61, wherein the means for updating comprises means for updating a history variable for a radio event that executes in a plurality of DUs based on respective DUs for which the radio event conflicts with at least one other radio event over a duration of the radio event.

71. The apparatus of claim 56, further comprising means for increasing a scale factor associated with an ongoing radio event during execution of the ongoing radio event in order to render the ongoing radio event less likely to be preempted by respective radio event combinations that do not include the ongoing event.

72. The apparatus of claim 56, further comprising:
means for identifying a new radio event for which no history exists; and
means for decreasing a history variable for the new radio event relative to corresponding history variables for respective existing radio events in order to render the new radio event more likely to be selected in a subsequent arbitration.

73. A computer program product, comprising:
a computer-readable medium, comprising:
code for causing a computer to identify data relating to respective radio events associated with a corresponding set of radios; and
code for causing a computer to select a radio event combination composed of the respective radio events based on at least one of bins to which the respective radio events are assigned, respective scale factors associated with the respective radio events, or respective history variables associated with the respective radio events.

74. An integrated circuit that executes a set of machine-executable instructions, the set of machine-executable instructions comprising:
obtaining information relating to respective radio events designated by respective corresponding radios; and
selecting a radio event combination from among the respective radio events based on at least one of bins, scale factors, or history variables associated with the respective radio events.
